(19) United States
(12) Patent Application Publication
(10) Pub. No.: US 2022/0415047 A1
(43) Pub. Date: Dec. 29, 2022

(54) SYSTEM AND METHOD FOR AUTOMATED VIDEO SEGMENTATION OF AN INPUT VIDEO SIGNAL CAPTURING A TEAM SPORTING EVENT

(71) Applicants: James ELDER, Toronto (CA); Hemanth PIDAPARTHY, North York (CA); Michael DOWLING, Aurora (CA)

(72) Inventors: James ELDER, Toronto (CA); Hemanth PIDAPARTHY, North York (CA); Michael DOWLING, Aurora (CA)

(21) Appl. No.: 17/808,322

(22) Filed: Jun. 23, 2022

Related U.S. Application Data
(60) Provisional application No. 63/215,352, filed on Jun. 25, 2021.

(51) Int. Cl. G06V 20/40; G06T 7/70; G06T 7/20; G06V 10/82

(52) U.S. Cl. CPC G06V 20/42; G06V 20/49; G06T 7/70; G06T 7/20; G06V 10/82; G06T 2207/10016; G06T 2207/30221; G06T 2207/20081; G06T 2207/20084

(57) ABSTRACT

There is provided a system and method for automated video segmentation of an input video signal. The input video signal capturing a playing surface of a team sporting event. The method including: receiving the input video signal; determining player position masks from the input video signal; determining optic flow maps from the input video signal; determining visual cues using the optic flow maps and the player position masks; classifying temporal portions of the input video signal for game state using a trained hidden Markov model, the game state comprising either game in play or game not in play, the hidden Markov model receiving the visual cues as input features, the hidden Markov model trained using training data comprising a plurality of visual cues for previously recorded video signals each with labelled play states; and outputting the classified temporal portions.

### TECHNICAL FIELD

The following relates generally to video processing technology; and more particularly, to systems and methods for automated video segmentation of an input video signal capturing a team sporting event.

### BACKGROUND

Most team sports games, such as hockey, involve periods of active play interleaved with breaks in play. When watching a game remotely, many fans would prefer an abbreviated game showing only periods of active play. Automation of sports videography has the potential to provide professional-level viewing experiences at a cost that is affordable for amateur sport. Autonomous camera planning systems have been proposed, however, these systems deliver continuous video over the entire game. Typical amateur ice hockey games feature between 40 and 60 minutes of actual game play. However, these games are played over the course of 60 to 110 minutes, with downtime due to the warm-up before the start of a period and the breaks between plays when the referee collects the puck and the players set up for the ensuing face-off. Also, there is a 15-minute break between periods for ice re-surfacing. Abbreviation of the video would allow removal of these breaks.

### SUMMARY

In an aspect, there is provided a computer-implemented method for automated video segmentation of an input video signal, the input video signal capturing a playing surface of a team sporting event, the method comprising: receiving the input video signal; determining player position masks from the input video signal; determining optic flow maps from the input video signal; determining visual cues using the optic flow maps and the player position masks; classifying temporal portions of the input video signal for game state using a trained hidden Markov model, the game state comprising either game in play or game not in play, the hidden Markov model receiving the visual cues as input features, the hidden Markov model trained using training data comprising a plurality of visual cues for previously recorded video signals each with labelled play states; and outputting the classified temporal portions.

In a particular case of the method, the method further comprising excising temporal periods classified as game not in play from the input video signal, and wherein outputting the classified temporal portions comprises outputting the excised video signal.

In another case of the method, the optic flow maps comprise horizontal and vertical optic flow maps.

In yet another case of the method, the hidden Markov model outputs a state transition probability matrix and a maximum likelihood estimate to determine a sequence of states for each of the temporal portions.

In yet another case of the method, the maximum likelihood estimate is determined by determining a state sequence that maximizes posterior marginals.

In yet another case of the method, the hidden Markov model comprises Gaussian Mixture Models.

In yet another case of the method, the hidden Markov model comprises Kernel Density Estimation.

In yet another case of the method, the hidden Markov model uses a Baum-Welch algorithm for unsupervised learning of parameters.

In yet another case of the method, the visual cues comprises maximum flow vector magnitudes within detected player bounding boxes, the detected player bounding boxes determined from the player position masks.

In yet another case of the method, the visual cues are outputted by an artificial neural network, the artificial neural network receiving a multi-channel spatial map as input, the multi-channel spatial map comprising the horizontal and vertical optic flow maps, the player position masks, and the input video signal, the outputted visual clues comprise conditional probabilities of the logit layers of the artificial neural network, the artificial neural network trained using previously recorded video signals each with labelled play states.

In another aspect, there is provided a system for automated video segmentation of an input video signal, the input video signal capturing a playing surface of a team sporting event, the system comprising one or more processors in communication with data storage, using instructions stored on the data storage, the one or more processors are configured to execute: an input module to receive the input video signal; a preprocessing module to determine player position masks from the input video signal, to determine optic flow maps from the input video signal, and to determine visual cues using the optic flow maps and the player position masks; a machine learning module to classify temporal portions of the input video signal for game state using a trained hidden Markov model, the game state comprising either game in play or game not in play, the hidden Markov model receiving the visual cues as input features, the hidden Markov model trained using training data comprising a plurality of visual cues for previously recorded video signals each with labelled play states; and an output module to output the classified temporal portions.

In a particular case of the system, the output module further excises temporal periods classified as game not in play from the input video signal, and wherein outputting the classified temporal portions comprises outputting the excised video signal.

In another case of the system, the optic flow maps comprise horizontal and vertical optic flow maps.

In yet another case of the system, the hidden Markov model outputs a state transition probability matrix and a maximum likelihood estimate to determine a sequence of states for each of the temporal portions.

In yet another case of the system, the maximum likelihood estimate is determined by determining a state sequence that maximizes posterior marginals.

In yet another case of the system, the hidden Markov model comprises Gaussian Mixture Models.

In yet another case of the system, the hidden Markov model comprises Kernel Density Estimation.

In yet another case of the system, the hidden Markov model uses a Baum-Welch algorithm for unsupervised learning of parameters.

In yet another case of the system, the visual cues comprises maximum flow vector magnitudes within detected player bounding boxes, the detected player bounding boxes determined from the player position masks.

In yet another case of the system, the visual cues are outputted by an artificial neural network, the artificial neural network receiving a multi-channel spatial map as input, the multi-channel spatial map comprising the horizontal and vertical optic flow maps, the player position masks, and the input video signal, the outputted visual clues comprise conditional probabilities of the logit layers of the artificial neural network, the artificial neural network trained using previously recorded video signals each with labelled play states.

These and other aspects are contemplated and described herein. It will be appreciated that the foregoing summary sets out representative aspects of the system and method to assist skilled readers in understanding the following detailed description.

### BRIEF DESCRIPTION OF THE DRAWINGS

A greater understanding of the embodiments will be had with reference to the figures, in which:

FIG. 1 illustrates a block diagram of a system for automated video segmentation of an input video signal capturing a team sporting event, according to an embodiment;

FIG. 2 illustrates a flow diagram of a method for automated video segmentation of an input video signal capturing a team sporting event, according to an embodiment;

FIG. 3A illustrates an example frame of a playing surface from a first camera;

FIG. 3B illustrates an example frame of a playing surface from a second camera;

FIG. 3C illustrates an example frame of a playing surface from a third camera;

FIG. 4 illustrates images of a playing surface from two different cameras to be stitched together;

FIG. 5A illustrates a template image of the playing surface of FIG. 4;

FIG. 5B illustrates a stitched image of the playing surface of FIG. 4;

FIG. 6 illustrates an example optic flow field within bounding boxes of detected players;

FIG. 7 illustrates a chart of error rate as a function of an L^{p} exponent used to aggregate the optic flow field of FIG. 6;

FIG. 8A illustrates an RGB image as an input feature map;

FIG. 8B illustrates a horizontal and vertical optical flow map as an input feature map;

FIG. 8C illustrates a binary player mask as an input feature map;

FIG. 9 is a diagram of a convolutional neural network (CNN) in accordance with the system of FIG. 1;

FIG. 10A illustrates spectral analysis of whistle and non-whistle intervals for a first game;

FIG. 10B illustrates spectral analysis of whistle and non-whistle intervals for a second game;

FIG. 10C illustrates spectral analysis of whistle and non-whistle intervals for a third game;

FIG. 11 illustrates visual and auditory cues for an example video segment;

FIG. 12A is a diagram of a state transition graph for 2-states;

FIG. 12B is a diagram of a state transition graph for 4-states;

FIG. 13A illustrates charts for conditional probability densities for a maximum optic flow and deep network probability of play visual cues from a first camera;

FIG. 13B illustrates charts for conditional probability densities for a maximum optic flow and deep network probability of play visual cues from a second camera;

FIG. 13C illustrates charts for conditional probability densities for a maximum optic flow and deep network probability of play visual cues from a third camera;

FIG. 14A illustrates a chart of conditional densities for a Wiener filter whistle detector on a first game;

FIG. 14B illustrates a chart of conditional densities for a Wiener filter whistle detector on a second game;

FIG. 14C illustrates a chart of conditional densities for a Wiener filter whistle detector on a third game; and

FIG. 15A illustrates charts of hidden Markov model performance for a first camera;

FIG. 15B illustrates charts of hidden Markov model performance for a second camera;

FIG. 15C illustrates charts of hidden Markov model performance for a third camera;

FIG. 16A illustrates charts of performance of deep visual cues for a first camera;

FIG. 16B illustrates charts of performance of deep visual cues for a second camera;

FIG. 16C illustrates charts of performance of deep visual cues for a third camera;

FIG. 17 illustrates conditional probability densities for maximum optic flow visual cue on all games across all three cameras;

FIG. 18 illustrates conditional probability densities for the deep visual cue on all games across all three cameras;

FIG. 19 shows conditional densities for the auditory cue of Wiener filter 3 detector on games from the third camera;

FIG. 20 shows an example of how the visual cue of maximum optic flow and auditory cue of Wiener filter 3 detector varies over time within each game state, for a 160-second sample video from Game 1 recorded using the third camera;

FIG. 21 shows an example of within-camera performance of a 2-state hidden Markov model (HMM) with visual cue only;

FIG. 22 shows an example of between-cameras performance compared to within-camera performance on all three cameras;

FIG. 23 illustrates an example of performance of the 2-state HMM and 4-state HMM on the third camera;

FIG. 24 illustrates an example of unconditional densities of the deep visual cue learned from the training data shown on the test data histogram for each game recorded using the third camera;

FIG. 25 illustrates an example of unconditional densities of the auditory cue learned from the training data shown on the test data histogram for each game recorded using the third camera; and

FIG. 26 illustrates an example of performance of the 2-state HMM before and after domain adaptation on all games from the first and second cameras.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine, or device exemplified herein that executes instructions may include or otherwise have access to computer-readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer-readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application, or module herein described may be implemented using computer readable/executable instructions that may be stored or otherwise held by such computer-readable media and executed by the one or more processors.

Embodiments of the present disclosure can advantageously provide a system that uses visual cues from a single wide-field camera, and in some cases auditory cues, to automatically segment a video of a sports game. For the purposes of this disclosure, the game considered will be hockey; however, the principles and techniques described herein can be applied to any suitable team sport with audible breakages in active play.

Some approaches have applied computer vision to sports using semantic analysis. For example, using ball detections and player tracking data, meaningful insights about individual players and teams can be potentially extracted. These insights can be used to understand the actions of a single player or a group of players and detect events in the game. Another form of semantic analysis is video summarization. Some approaches have analyzed broadcast video clips to stitch together a short video of highlights. However, this summarized video is short for consumption and cannot be used for tagging of in-game events, analysis of team tactics, and the like, because the summary video does not retain all the active periods of play. Sports such as soccer, ice hockey and basketball have many stoppages during the game. Thus, the present embodiments advantageously divide the captured game into segments of active play and no-play, known as play-break segmentation.

Some approaches to determine play-break segmentation can use play-break segmentation for automatic highlight generation or event detection, or can use event detection to guide play-break segmentation. Most of such approaches use rule-based approaches that combine text graphics on a broadcast feed with audio cues from the crowd and commentator or the type of broadcast camera shot. These approaches generally use broadcast cues (camera shot type) or production cues (graphics and commentary) for play-break segmentation, and thus are not directly relevant to unedited amateur sport video recorded automatically with fixed cameras.

While unedited videos can be used in some approaches to detect in-game events (such as face-off, line change, and play in ice hockey) and then use the rules of the sport to determine segments of play and no-play. In such approaches, an support-vector-machine (SVM) was trained on Bag-of-Words features to detect in-game events in video snippets. At inference, an event was predicted for each video snippet and it was classified as play or no-play segments using the rules of the sport. However, this approach requires training and evaluating on disjoint intervals of a single game recorded by two different cameras.

The present embodiments provide significant advantages over the other approaches by, for example, classifying frames as play and no-play without requiring the detection of finer-grain events like line changes. Additionally, temporal dependencies between states can be captured and integrated with probabilistic cues within a hidden Markov model (HMM) framework that allows maximum a-posteriori (MAP) or minimum-loss solutions to be computed in linear time. Further, the present embodiments allow for handling auditory domain shift that is critical for integration with visual cues. Further, the present embodiments are generalizable across games, rinks, and viewing parameters.

In the present disclosure, two different visual cues are described. The first visual clue is based on the optic flow; players tend to move faster during play than breaks. However, in some cases, motion on the ice can sometimes be substantial during breaks and sometimes quite limited during periods of play. In this way, the present embodiments use a more complex deep visual classifier that takes not only the optic flow as input but also an RGB image and detected player positions as input.

In some cases of the present disclosure, utility of auditory cues, such as the referee whistle that starts and stops play, can be used. While not directly informative of the current state, the whistle does serve to identify the timing of state transitions, and thus can potentially contribute to performance of the automation.

In some cases, to take into account temporal dependencies, a hidden Markov model (HMM) can be used, which, while advantageously simplifying modeling through conditional independence approximations, allows (1) optimal probabilistic integration of noisy cues and (2) an account of temporal dependencies captured through a state transition matrix. In some cases, a technique for unsupervised domain adaptation of the HMM can be used; iteratively updating emission and/or transition probability distributions at inference, using the predicted state sequence. This is particularly useful for benefitting from auditory cues as input.

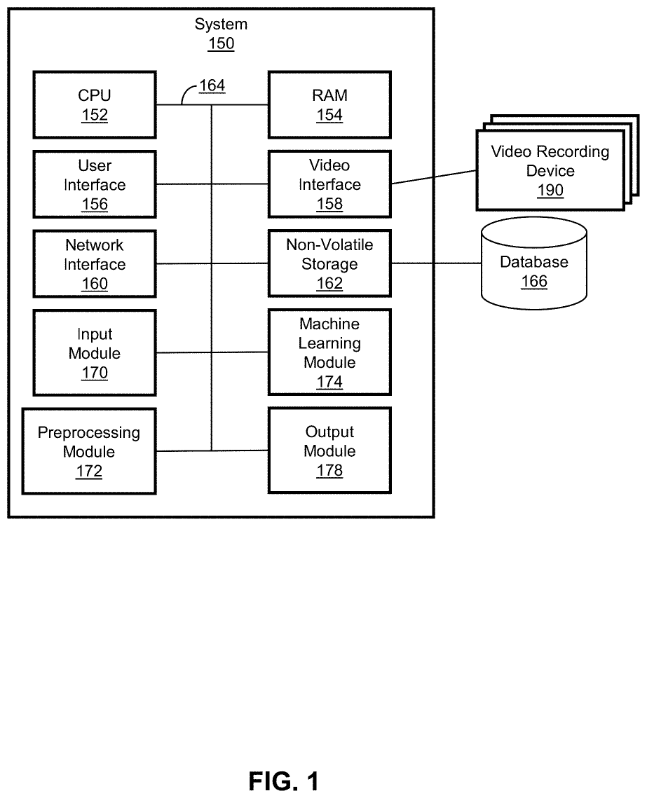

Turning to FIG. 1, a system for automated video segmentation of an input video signal capturing a team sporting event 150 is shown, according to an embodiment. In this embodiment, the system 150 is run on a local computing device (for example, a personal computer). In further embodiments, the system 150 can be run on any other computing device; for example, a server, a dedicated piece of hardware, a laptop computer, or the like. In some embodiments, the components of the system 150 are stored by and executed on a single computing device. In other embodiments, the components of the system 150 are distributed among two or more computer systems that may be locally or remotely distributed; for example, using cloud-computing resources.

FIG. 1 shows various physical and logical components of an embodiment of the system 150. As shown, the system 150 has a number of physical and logical components, including a central processing unit (“CPU”) 152 (comprising one or more processors), random access memory (“RAM”) 154, a user interface 156, a video interface 158, a network interface 160, non-volatile storage 162, and a local bus 164 enabling CPU 152 to communicate with the other components. CPU 152 executes an operating system, and various conceptual modules, as described below in greater detail. RAM 154 provides relatively responsive volatile storage to CPU 152. The user interface 156 enables an administrator or user to provide input via an input device, for example a mouse or a touchscreen. The user interface 156 can also output information to output devices, such as a display or speakers. In some cases, the user interface 156 can have the input device and the output device be the same device (for example, via a touchscreen). The video interface 158 can communicate with one or more video recording devices 190, for example high-definition video cameras, to capture a video of a sporting event. In further embodiments, the video interface 158 can retrieve already recorded videos from the local database 166 or a remote database via the network interface 160.

The network interface 160 permits communication with other systems, such as other computing devices and servers remotely located from the system 150, such as for a typical cloud-computing model. Non-volatile storage 162 stores the operating system and programs, including computer-executable instructions for implementing the operating system and modules, as well as any data used by these services. Additional stored data can be stored in a database 166. During operation of the system 150, the operating system, the modules, and the related data may be retrieved from the non-volatile storage 162 and placed in RAM 154 to facilitate execution.

In an embodiment, the system 150 further includes a number of modules to be executed on the one or more processors 152, including an input module 170, a preprocessing module 172, a machine learning module 174, and an output module 176.

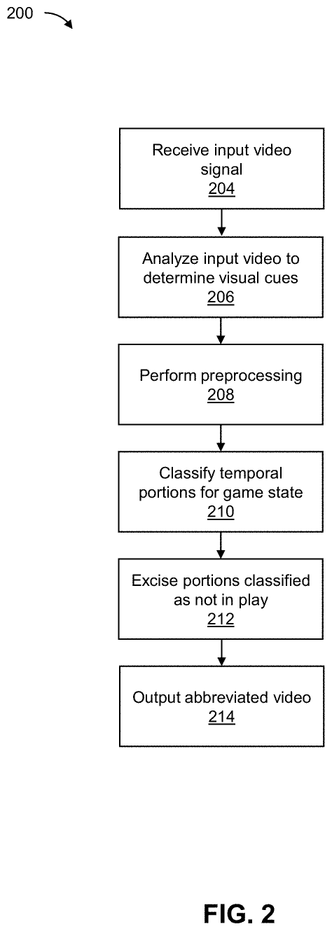

FIG. 2 illustrates a method 200 for automated video segmentation of an input video signal capturing a team sporting event, in accordance with an embodiment. At block 204, the input module 170 receives an input video signal capturing a team sporting event; for example, a hockey game. The input video signal capturing a playing surface, or at least a substantial portion of the playing surface, of the team sporting event.

At block 206, the input video signal is analyzed by the preprocessing module 172 for visual cues. In an example, the visual cues can be determined from, for example, maximizing optical flow maps or an artificial neural network using one or more contextual feature maps as input. In an embodiment, the contextual feature maps can include one or more of (1) raw color imagery, (2) optic flow map, and (3) binary player position masks. In some cases, a full input representation includes a 6-channel feature map of a combination of the previously listed three types of feature maps.

In an example, the raw color imagery can be encoded in three channels: red, green, and blue (RGB). These three channels are present in the original RGB channels of the captured image.

In an example, the binary player position masks can have each player represented as a rectangle of 1s on a background of 0s. The binary player masks can be generated using a Faster RCNN object detector (Ren, S., He, K., Girshick, R., and Sun, J. Faster R-CNN: Towards real-time object detection with region proposal networks. In Advances in Neural Information Processing Systems (2015), pp. 91-99). However, any suitable person detecting technique could be used.

In an example, the optic flow can be coded in two channels representing x and y components (i.e., horizontal and vertical) of flow field vectors. These optic flow vectors can be computed using Farneback's dense optical flow algorithm (Two-frame motion estimation based on polynomial expansion. In Scandinavian Conference on Image analysis, pages 363-370, 2003). In further cases, any optic flow technique could be used. In some cases, the optic flow can be limited to portions of the imagery identified to have players by the binary player masks.

It is appreciated that in further examples, other suitable coding schemes can be used based on the particular contextual feature maps.

At block 208, in some embodiments, the preprocessing module 172 performs preprocessing on the coded contextual feature map data. In some cases, the preprocessing module 174 processes the feature maps by, for example, normalization to have zero mean and unit variance, resizing (for example, to 150×60 pixels), and then stacking to form the 6-channel input.

In some cases, the preprocessing module 172 can augment training data by left-right mirroring. Team labels can be automatically or manually assigned such that a first channel of a player mask represents a ‘left team’ and a second channel of the player mask represents a ‘right team.’

At block 210, the machine learning module 178, using a trained machine learning model, such as a hidden Markov model, to classify temporal portions of the input video signal for game state. The game state comprising either game in play or game not in play. The hidden Markov model receiving the visual cues as input features. The hidden Markov model trained using training data comprising a plurality of previously recorded video signals each with manually identified play states. In further cases, other suitable models can be used, such as a long-short-term memory model (LSTM) model could be used instead.

At block 212, the output module 180 can excise the temporal portions classified as game not in play; resulting in an abbreviated video with only the temporal portions classified as game in play.

At block 214, the output module 184 outputs the abbreviated video. The output module 184 outputs to at least one of the user interface 156, the database 166, the non-volatile storage 162, and the network interface 160.

Visual cues can be used by the system 150 for classifying video frames individually as play/no-play and auditory cues can be used by the system 150 for detecting auditory changes of the play state (such as whistles). In order to put these cues together and reliably excise periods of non-play, the machine learning model should capture statistical dependencies over time. For example, employing the aforementioned hidden Markov model (HMM). A Markov chain is a model of a stochastic dynamical system that evolves in discrete time over a finite state space, and that follows the Markov property or assumption. The Markov property states that when conditioned on the state at time t, the state at time t+1 is independent of all other past states. Thus, when predicting the future, the past does not matter, only the present is taken into consideration. Consider a sequence of observations O={o₁, o₂, . . . , o_{T}} and a state sequence Q={q₁, q₂, . . . , q_{T}}. The Markov property is mathematically represented as:

qᵢ|q₁, . . . , qᵢ₋₁)=P(qᵢ|qᵢ₋₁) (1)

The Markov chain is specified by two components: 1) initial probability distribution over the states and 2) state transition probabilities.

HMM is a model that is built upon Markov chains. A Markov chain is useful when the probability for a sequence of observable states is to be computed. However, sometimes the states of interest are hidden, such as play and no-play states in videos of sporting events. An HMM is a model that consists of a Markov chain whose state at any given time is not observable; however, at each instant, a symbol is emitted whose distribution depends on the state. Hence, the model is useful for capturing distribution of the hidden states in terms of observable quantities known as symbols/observations. In addition to the Markov property given by Equation (1), the HMM has an extra assumption that given the state at that instant, the probability of the emitted symbol/observation is independent of any other states and any other observations. This is mathematically represented as:

P(oᵢ|q₁, . . . , qᵢ, . . . , q_{T}, o₁, . . . , oᵢ, . . . , o_{T})=P(oᵢ|qᵢ) (2)

An HMM is specified by the following parameters:
Initial probability distribution over states, πᵢ, such that Σᵢ₌₁^{N}πᵢ=1.
State transition probability matrix A, where each element aᵢⱼ represents the probability of moving from state i to state j, such that Σⱼ₌₁^{N} aᵢⱼ=1∀i.
Emission probabilities B=bᵢ(oₜ), which indicates the probability of an observation oₜ being generated from state i.

An HMM is characterized by three learning problems:
Likelihood: Given an HMM λ=(A, B) and an observation sequence O, determine the likelihood of P(O|λ).
Decoding: Given an HMM λ=(A, B) and an observation sequence O, what is the best sequence of hidden states Q.
Learning: Given an observation sequence O and the set of possible states in the HMM, learn the HMM parameters A and B.

The system 150 uses HMM to determine if a given frame belongs to a play segment or a no-play segment, and the observations emitted are the visual cue, and in some cases, the auditory cue. After learning the model, given the sequence of visual and optional auditory observations, it is used to estimate whether each frame belongs to play or no-play states.

Since the training data includes a labelled sequence of states, the HMM can be used to estimate the state transition probability matrix and determine a maximum likelihood estimate for a given state. Similarly, the observation likelihoods can be modelled from the training data. The present disclosure provides two different approaches to model the likelihoods: (1) Gaussian Mixture Models (GMMs) and (2) Kernel Density Estimation (KDE); however, any suitable approach can be used.

A Gaussian Mixture Model (GMM) is a probabilistic model that fits a finite number of Gaussian distributions with unknown parameters to a set of data points. The GMM is parameterized by the means and variances of the components and the mixture coefficients. For a GMM with K components, the i^{th} component has a mean μᵢ, variance σᵢ² and component weight of ϕᵢ. The probability density function, f(x), of a such a GMM is given as:

$$f ( x ) = {\sum }_{i = 1}^{K} {ϕ}_{i} \frac{1}{\sqrt{2 π {σ}_{i}^{2}}} exp ( - \frac{{( x - {μ}_{i} )}^{2}}{2 {σ}_{i}^{2}} ) \qquad ( 3 )$$

The mixing/component weights ϕᵢ satisfy the constraint Σᵢ₌₁^{K} ϕᵢ=1. If the number of components in the GMM is known, the model parameters can be estimated using the Expectation Maximization (EM).

An alternative non-parametric approach to modelling the likelihoods is Kernel Density Estimation (KDE). Gaussian KDE approximates the probability density at a point as the average of Gaussian kernels centered at observed values. The probability density function, f(x), for Gaussian KDE is given as:

$$f ( x ) = \frac{1}{N} {\sum }_{j = 1}^{N} \frac{1}{\sqrt{2 π {σ}^{2}}} exp ( - \frac{{( x - {x}_{j} )}^{2}}{2 {σ}^{2}} ) \qquad ( 4 )$$

where N is the total number of data points.

Although KDE is expressed as a Gaussian mixture, there are two major differences to the GMM density in Equation (3). First, the number of Gaussian components in Equation (4) is N (the number of data points), which is typically significantly more than the M components in a GMM (Equation (3)). Second, the variance, σ², is the same for all components in Equation (4). The only parameter to be estimated for KDE is the variance, σ². It can be estimated using Silverman's rule.

The learned state transition matrix and the emission probabilities can be used at inference to estimate the sequence of states. In an example, an approach to determine the optimal sequence of hidden states is the Viterbi algorithm. It determines the maximum a posteriori sequence of hidden states, i.e., the most probable state sequence. As a result, it is difficult to tune to control type 1 and type 2 errors. Instead, the marginal posteriors are estimated at each time instant. A threshold can then be adjusted to achieve the desired balance of type 1 and type 2 errors.

Let O={o₁, o₂, . . . , o_{T}} be the sequence of observations and Q={q₁, q₂, . . . , q_{T}} be a sequence of hidden states. qₜ ∈ {1,2, . . . , N}, where N is the number of states; N=2 can be used in the present embodiments. T is the number frames in the video. The maximum posterior of marginals (MPM) returns the state sequence Q, where:

Q={arg max_{q1}P(q₁|o₁, . . . , o_{T}), . . . , arg max_{qT}P(q_{T}|o₁, . . . , o_{T})} (5)

Let λ=(A, B) be an HMM model with state transition matrix A and emission probabilities B. The posterior probability of being in state j at time t is given as:

$${γ}_{t} ( j ) = P ( {q}_{t} = j \vert O , λ ) = \frac{P ( {q}_{t} = j , O \vert λ )}{P ( O \vert λ )} \qquad ( 6 )$$

The forward probability, αₜ(j), is defined as the probability of being in state j after seeing the first t observations, given the HMM λ. The value of αₜ(j) is computed by summing over the probabilities of all paths that could lead to the state j at time t. It is expressed as:

αₜ(j)=P(o₁, o₂, . . . , oₜ, qₜ=j|λ)=Σᵢ₌₁^{N} αₜ₋₁(i)aᵢⱼbⱼ(oₜ) (7)

where aᵢⱼ is the state transition probability from previous state qₜ₋₁=i to current state qₜ=j. αₜ₋₁(i) is the forward probability of being in state i at time t−1, and it can be recursively computed.

The backward probability, βₜ(j), can be defined as the probability of seeing the observations from time t+1 to T, given that it is in state j at time t and given the HMM λ. It can be expressed as:

βₜ=P(oₜ₊₁, oₜ₊₂, . . . , o_{T}|qₜ=j,λ)=Σᵢ₌₁^{N} aⱼᵢbⱼ(oₜ₊₁)βₜ₊₁(i) (8)

where βₜ₊₁(i) is the backward probability being in state i at time t+1, and can be computed recursively.

Putting the forward probability (αₜ(j)) and backward probability (βₜ(j)) in Equation (6), the posterior probability γₜ(j) is given as:

$${γ}_{t} ( j ) = \frac{{α}_{t} ( j ) {β}_{t} ( j )}{{\sum }_{i = 1}^{N} {α}_{t} ( i ) {β}_{t} ( i )} \qquad ( 9 )$$

The state sequence maximizing the posterior marginals (MPM) is computed as:

Q={arg maxⱼγ₁(j), arg maxⱼγ₂(j), . . . , arg maxⱼγ_{T}(j)} (10)

In the present embodiments, mislabeling a play state as a no-play state might be more serious than mislabeling a no-play state as a play state, as the former could lead to the viewer missing a key part of the game, whereas the latter would just waste a portion of time. Thus, rather than selecting the MPM solution, the threshold on the posterior can be adjusted to achieve a desired trade-off between the above.

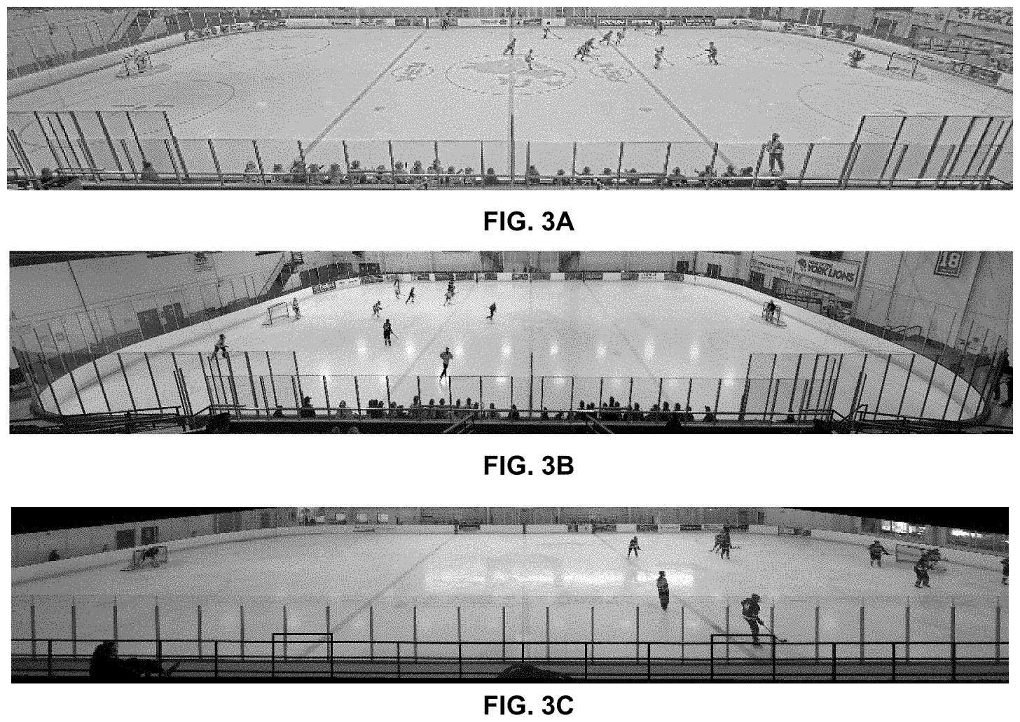

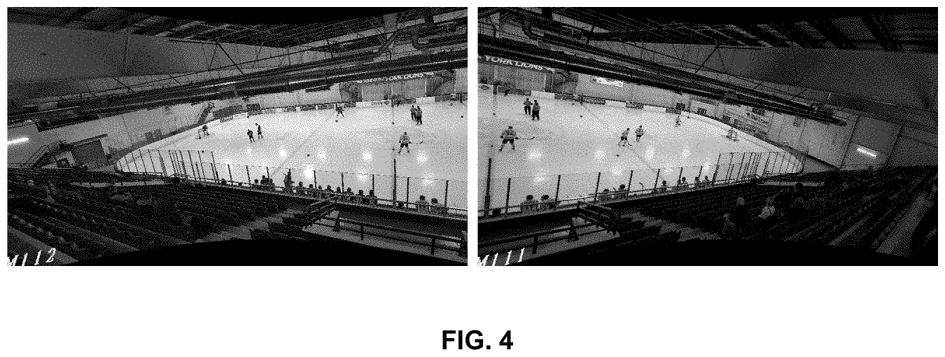

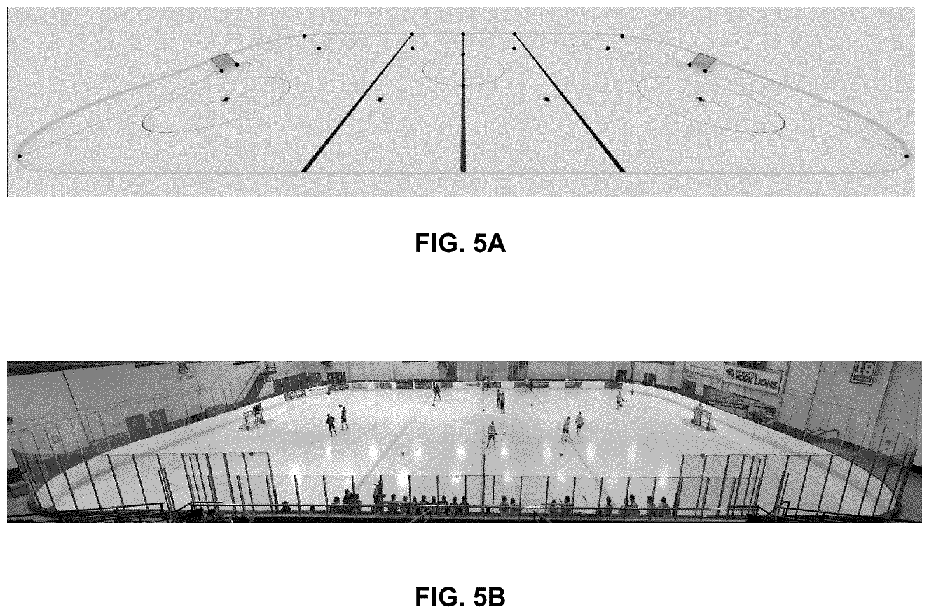

Using an example of the present embodiments, the present inventors experimentally verified at least some of the advantages of the present embodiments. A dataset for the example experiments consisted of 12 amateur hockey games recorded using three different high-resolution 30 frames-per-second (fps) camera systems, placed in the stands, roughly aligned with the center line on the ice rink and about 10 m from the closest point on the ice.
Camera 1: Four games were recorded using a 4K Axis P1368-E camera (as illustrated in FIG. 3A).
Camera 2: Five games were recorded using two 4K IP cameras with inter-camera rotation of 75 deg (as illustrated in FIG. 3B). Nonlinear distortions were removed and a template of the ice rink was employed (as illustrated in FIG. 5A) to manually identify homographies between the two sensor planes (as illustrated in FIG. 4) and the ice surface. These homographies were used to reproject both cameras to a virtual cyclopean camera bisecting the two cameras, where the two images were stitched using a linear blending function (as illustrated in FIG. 5B).
Camera 3: Three games were recorded using a 4K wide-FOV GoPro 5 camera (as illustrated in FIG. 3C), which also recorded synchronized audio at 48 kHz.

Camera 1 and Camera 2 were placed roughly 8 meters and Camera 3 roughly 7 meters above the ice surface. The substantial radial distortion in all the videos was corrected using calibration. To assess generalization over camera parameters, the roll and tilt of Camera 3 was varied by roughly ±5 deg between games and periods.

The 12 recorded games in the example experiments were ground-truthed by marking the start and end of play intervals. For Cameras 1 and 2, the start of play was indicated as the time instant when the referee dropped the puck during a face-off and the end of play by when the referee was seen to blow the whistle. Since there was audio for Camera 3, state changes were identified by the auditory whistle cue, marking both the beginning and end of whistle intervals, which were found to average 0.73 sec in duration.

While the example experiments were generally trained and evaluated within camera systems, the experiments show that our deep visual cues generalize well across different camera systems as well as modest variations in extrinsic camera parameters. For all three camera systems, training and evaluation was performed on different games, using leave-one-game-out k-fold cross-validation.

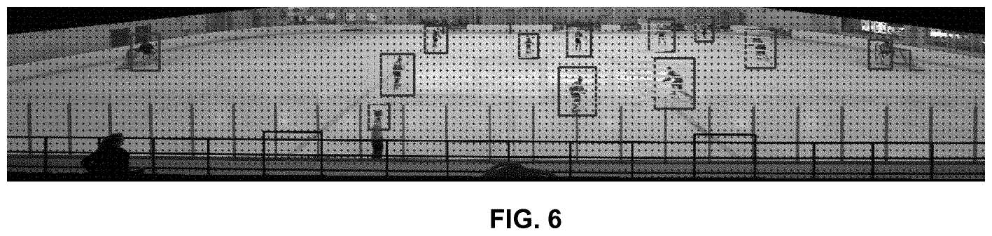

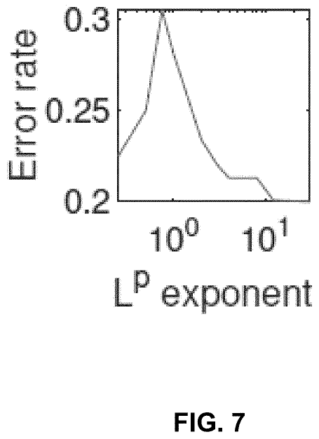

An OpenCV implementation of Farneback's dense optic flow algorithm was used and the flow fields lying within bounding boxes of players were detected using a Faster-RCNN detector, fine-tuned on three games recorded using Camera 2 that were not part of this dataset; this implementation is illustrated in FIG. 6. Motion energy is generally higher during periods of play than during breaks, but given the sparse nature of the flow it is not immediately obvious how to optimally aggregate the flow signal to create the strongest classifier. The example experiments assessed a range of L^{p} norms over the optic flow vector magnitudes for Game 1 recorded using Camera 3, measuring classification error for distinguishing play from no-play states (illustrated in FIG. 7). It was determined that error rate was lowest for very high exponents, which leads to a very simple and computationally efficient visual cue: the L^{∞} norm of the optic flow, i.e., the maximum flow vector magnitude within detected player boxes.

In some cases, the maximum optic flow visual cue can be problematic where motion on the playing surface can sometimes be substantial during breaks and sometimes quite limited during periods of play.

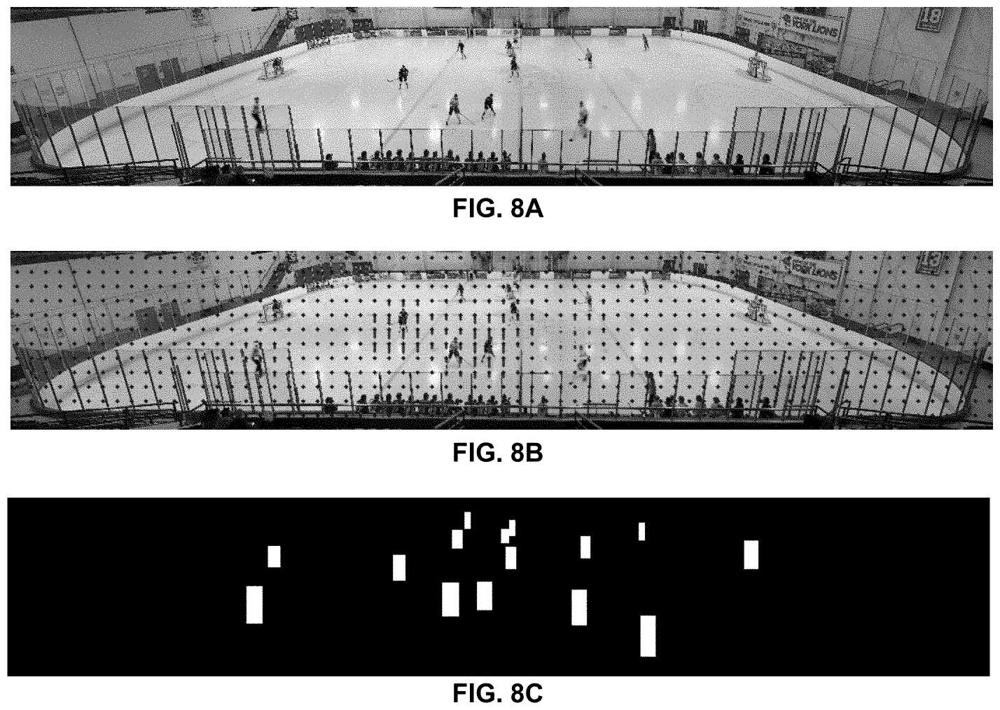

A small deep classifier, an artificial neural network, can be used to allow end-to-end training for play/no-play classification using a multi-channel feature map as input and outputting the probability distruction at the logit layers. (For Camera 3, whistle frames were included in the play intervals). The 6 channels of input consisted of a) the RGB image as illustrated in FIG. 8A, b) horizontal and vertical optic flow maps as illustrated in FIG. 8B, and c) binary player position mask as illustrated in FIG. 8C. The feature maps were normalized to have zero mean and unit variance, resized to 150×60 pixels, and then stacked to form a 6-channel input. The training dataset was augmented by left-right mirroring. In a particular case, the artificial neural network can be a convolutional neural network that is trained to classify each frame as belonging to play or no-play classes; however, any suitable artificial neural network can be used.

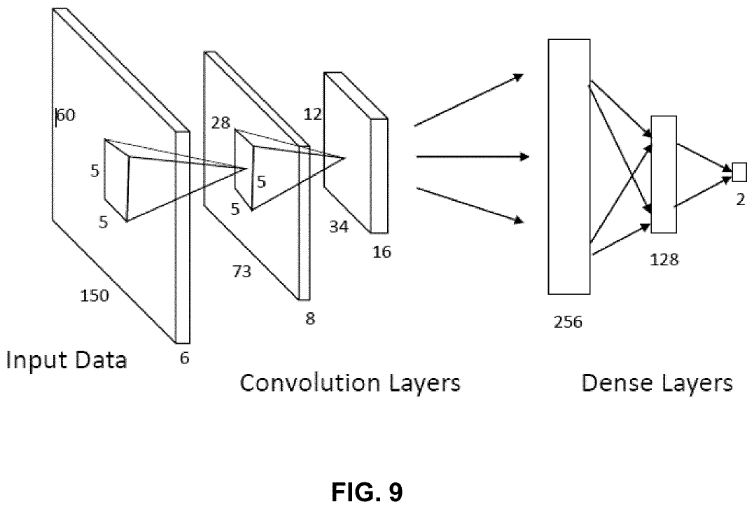

The artificial neural network consisted of two cony-pool modules followed by two fully connected layers; as illustrated in the diagram of FIG. 9. A max pooling layer followed each convolution layer and dropout was used between every fully connected layer. The output from the network was the softmax probability of the frame belonging to play or no-play classes. Cross-entropy loss between the predicted class and ground truth class was minimized using a stochastic gradient descent (SGD) optimizer. The model was trained for 20 epochs with an initial learning rate of 0.01 and weight decay of 0.01. The learning rate was decreased by 50% every 5 epochs.

The pre-softmax (logit) layer output difference of the trained model can be used as the visual cue. A separate model was trained for each camera. For Cameras 1 and 2, one game was used for validation and one for test, and the remaining games used for training. For Camera 3, one game was used for test, one period from one of the other games was used for validation, and the remaining data were used for training.

To determine the visual cues, the present inventors evaluated the performance of four visual classifiers in classifying each frame as belonging to play and no-play. The performance of the classifier was measured in terms of the Area Under Curve (AUC) score. The AUC score measures the area under the Receiver Operating Characteristic (ROC) curve. The ROC curve plots the true positive rate (TPR) against the false positive rate (FPR) for different thresholds. It measures the ability of a classifier to distinguish between classes at a given threshold. The AUC score summarizes the performance of a classifier across all thresholds. AUC score takes values in [0,1], with 0 indicating a classifier that classifies all positive examples as negative and all negative examples as positive, and 1 indicating a classifier that correctly classifies all positive and negative samples.

For each camera, the AUC score was measured through leave-one-out cross validation, and was averaged across all cross-validation folds. The results are shown in TABLE 1. The AUC scores of all four visual classifiers are good across all cameras, indicating that these cues/classifiers are good at differentiating play and no-play frames. Across all cameras, the performance of the baseline classifier with a deep network (ResNet18+FC) was better than that of the baseline classifier with SVM (ResNet18+SVM). The performance of all classifiers are worse on Camera 3 than Cameras 1 and 2. This was because the roll and tilt varied across different games recorded using Camera 3, while Cameras 1 and 2 were fixed stationary cameras.

The performance of the maximum optic flow visual cue is worse than the baselines on Cameras 1 and 2. However, on Camera 3, the AUC score is significantly better. Since the camera roll is varied across different games, maximum optic flow cue is less affected by these changes than the ResNet18 model whose input is the RGB image. Across all cameras, the best performance was obtained using our deep visual cue.

The present inventors compared our two visual classifiers against two baseline deep classifiers trained to use as input the 512-dimensional output from the final fully connected layer of the ImageNet-trained ResNet18 network. The first classifier consisted of two fully connected layers of dimensions 128 and 64, followed by a play/no-play softmax layer. The learning rate for this network was 0.001, weight decay was 0.01 and it was trained for 10 epochs. The second classifier was an SVM using an RBF kernel. TABLE 1 shows performance of the four visual classifiers. Across all cameras, the best performance was obtained using the end-to-end trained deep visual classifier of the present embodiments.

TABLE 1

| | AUC scores | | |
|---|---|---|---|
| | Camera 1 | Camera 2 | Camera 3 |
| Resnet18 + FC | 0.923 ± 0.018 | 0.907 ± 0.052 | 0.598 ± 0.03 |
| Resnet18 + SVM | 0.884 ± 0.009 | 0.844 ± 0.014 | 0.545 ± 0.01 |
| Maximum optic flow | 0.885 ± 0.011 | 0.818 ± 0.008 | 0.799 ± 0.028 |
| End-to-end deep | 0.977 ± 0.004 | 0.966 ± 0.005 | 0.819 ± 0.053 |
| classifier | | | |

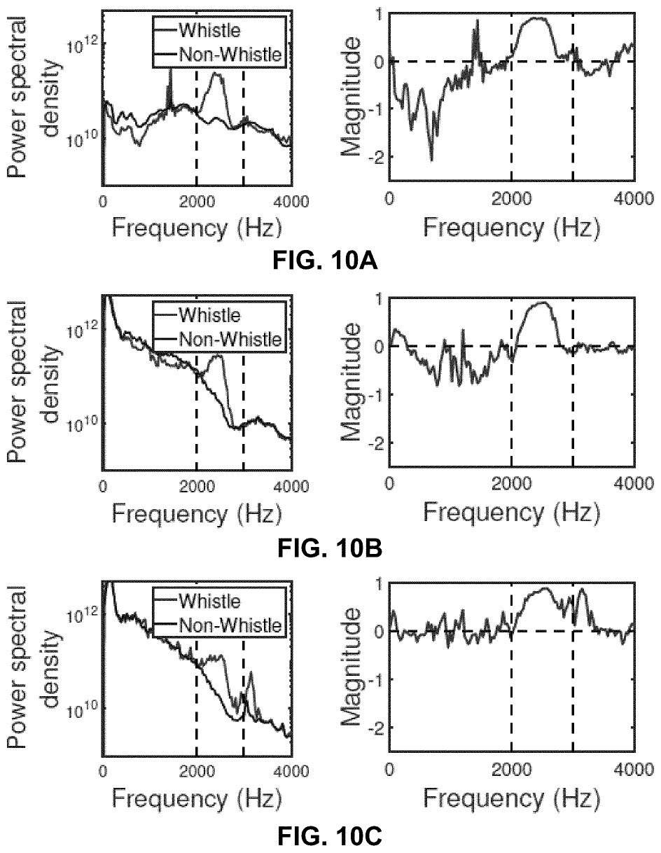

In ice hockey, referees blow their whistles to start and stop play. Therefore, the present inventors explored the utility of auditory cues for classifying play and no-play frames. While not directly informative of the current state, the whistle can serve as an indicator of transitions between the play state and no-play state. For Camera 3, the audio signal was partitioned into 33 msec intervals, temporally aligned with the video frames. Since the audio was sampled at 48 kHz, each interval consisted of 1,600 samples. The audio samples in each interval were normalized to have zero-mean and the power spectrum density (PSD) for each interval was determined as P(f)=S(f)S*(f); where S(f) and S*(f) are the Fourier Transform and conjugate Fourier Transform of an interval of audio samples at the frequency f. FIGS. 10A to 10C show the power spectral density (PSD) averaged over whistle and non-whistle intervals for the three games recorded using Camera 3 (FIG. 10A shows Game 1; FIG. 10A shows Game 2; and FIG. 10C shows Game 3). These plots reveal several important facts. First, the overall volume of sound varies widely from game to game: While Game 1 is relatively quiet, Games 2 and 3 are quite noisy, with a lot of power in the low frequencies. Second, most of the whistle power lies in the 2-3 kHz range, however that power is not distributed evenly and the power of that signal and hence the signal-to-noise ratio varies widely from game to game.

To form a decision variable for each interval, the example experiments considered two candidate detectors:
Bandpass filter. The integral of the power spectral density (PSD) over the 2-3 kHz band was determined. This is probabilistically optimal if both the signal and noise are additive, stationary, white Gaussian processes and the PSDs are identical outside this band.
Wiener filter. FIGS. 10A to 10C show that in fact the signal and noise are not white. Relaxing the condition that the PSDs be white and identical outside the 2-3 kHz band, for longer intervals (many samples), it can be shown that probabilistically near-optimal detection is achieved by taking the inner product of the stimulus PSDs with the Wiener filter:

$$H ( f ) = \frac{{P}_{ss} ( f )}{{P}_{ss} ( f ) + {P}_{nn} ( f )} \qquad ( 11 )$$

where Pₛₛ(f) and Pₙₙ(f) are the PSD of the signal (whistle) and noise, respectively, as a function of frequency f.

In the present case, there is not direct knowledge of the whistle and noise PSDs and so they must be estimated from the training data:

Pₛₛ(f)≈P_{W}(f)−P_{NW}(f) (12)

Pₙₙ(f)≈P_{NW}(f) (13)

where P_{W}(f) and P_{NW}(f) are the average PSDs over whistle and non-whistle training intervals, respectively. Thus:

$$H ( f ) \approx \frac{{P}_{W} ( f ) - {P}_{NW} ( f )}{{P}_{W} ( f )} \qquad ( 14 )$$

$$= 1 - \frac{{P}_{NW} ( f )}{{P}_{W} ( f )} \qquad ( 15 )$$

The right-side charts in FIGS. 10A to 10C show the resulting Weiner filters H(f) estimated for each of the three games recorded by Camera 3. The filter is largely positive in the 2-3 kHz range but can become negative outside this range. This suggests that in fact the signals are not exactly stationary and/or additive. Two possibilities are that some acoustic signals are more likely to occur in non-whistle than in whistle intervals, and that, when the whistle is blown, auto-gain circuitry in the camera attenuates energy outside the whistle band. To handle these deviations from assumptions, the example experiments evaluated three versions of the Wiener filter:
Wiener filter 1. Take the inner product of the stimulus with the estimated Wiener filter over the entire frequency range, including negative values.
Wiener filter 2. Take the inner product of the stimulus with the rectified Wiener filter (negative values clipped to 0).
Wiener filter 3. Take the inner product of the stimulus with the rectified Wiener filter (negative values clipped to 0), only over the 2-3 kHz range.

TABLE 2 shows average area under curve (AUC) scores for these four detectors using three-fold cross-validation on the three games recorded using Camera 3. Overall, the Wiener filter 3 detector performed best. Its advantage over the bandpass filter presumably derives from its ability to weight the input by the non-uniform SNR within the 2-3 kHz band. Its advantage over the other two Wiener variants likely reflects the inconsistency in the PSD across games outside this band.

TABLE 2

| | AUC score |
|---|---|
| Bandpass filter | 0.919 ± 0.039 |
| Wiener filter 1 | 0.779 ± 0.105 |
| Wiener filter 2 | 0.809 ± 0.093 |
| Wiener filter 3 | 0.943 ± 0.028 |

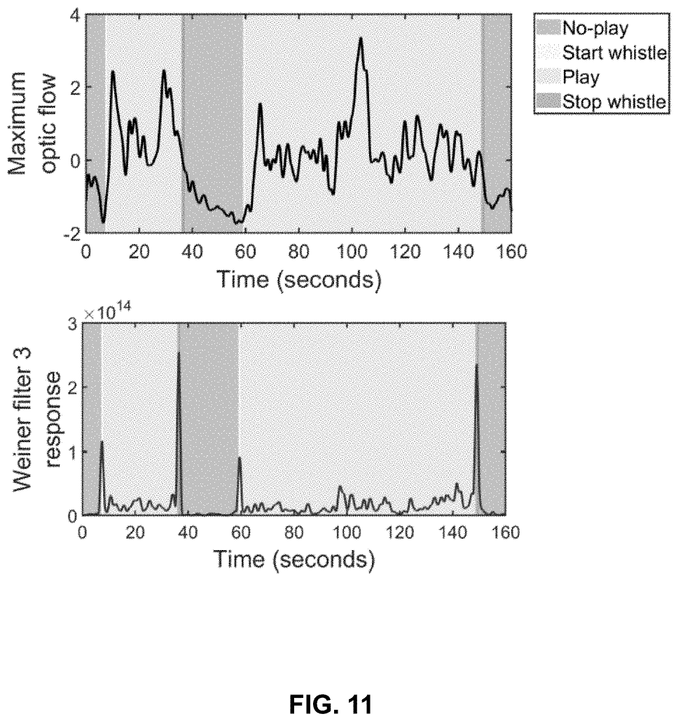

Visual cues are seen to be useful for classifying video frames individually as play/no-play and auditory cues are useful for detecting the whistle. In order to put these cues together and reliably excise periods of non-play from the entire video, a model should capture statistical dependencies over time. FIG. 11 shows an example of how the visual maximum optic flow and auditory cues vary over time within each game state, for Camera 3 in Game 1.

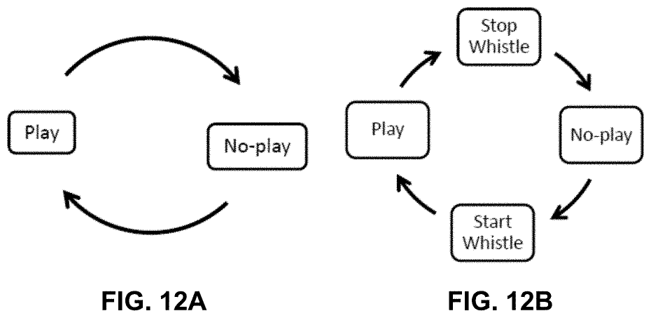

To capture these statistical dependencies, some of the example experiments employed a hidden Markov model (HMM) of play state. For Cameras 1 and 2 (visual only), the example experiments employed a 2-state model (play/no-play) (as illustrated in FIG. 12A). For Camera 3 (with audio), the example experiments employed a 4-state model that includes start and stop whistle states (as illustrated in FIG. 12B). TABLE 3 shows the state mean transition probabilities learned from the labelled data.

TABLE 3

| Camera | Transition | Probability |
|---|---|---|
| 1 | No-play→Play | 0.00038 |
| 1 | Play→No-play | 0.00053 |
| 2 | No-play→Play | 0.00092 |
| 2 | Play→No-play | 0.00054 |
| 3 | No-play→Start | 0.00117 |
| | Whistle | |
| 3 | Start | 0.04973 |
| | Whistle→Play | |
| 3 | Play→Stop | 0.00050 |
| | Whistle | |
| 3 | Stop | 0.04709 |
| | Whistle→No-play | |

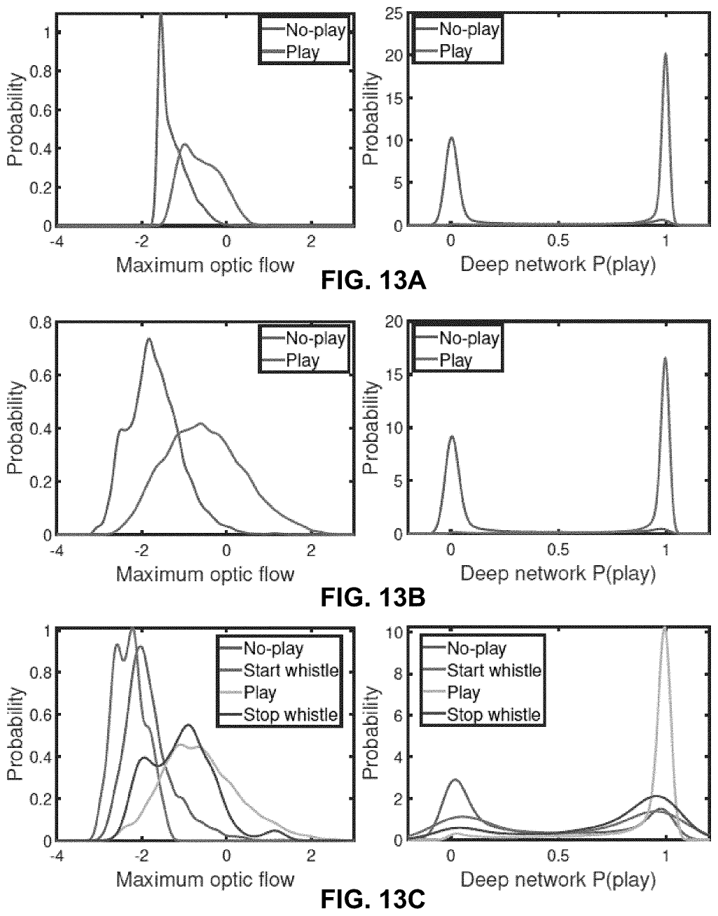

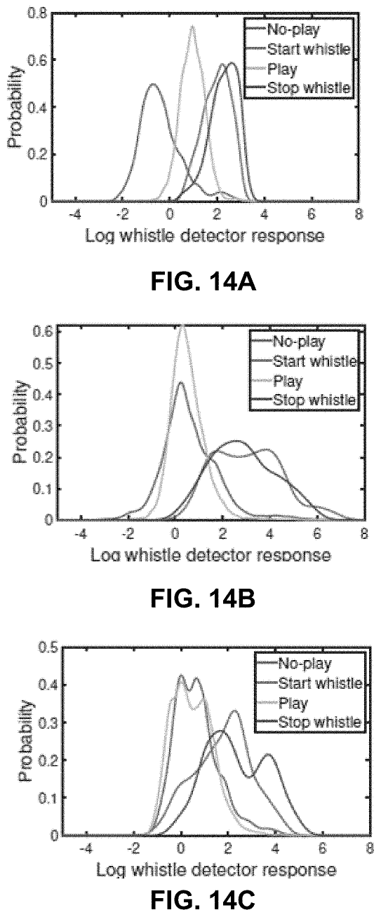

In addition to the state transition probabilities, emission distributions for the observed visual and auditory cues are determined, which can be treated as conditionally independent. In a particular case, the densities were determined using Gaussian kernel density estimation with bandwidth selected by Silverman's rule. FIGS. 13A to 13C show these conditional distributions for one game from Camera 1, Camera 2, and Camera 3, respectively; and for two visual cues: the maximum optic flow cue, normalized to have zero mean and unit variance, and the softmax confidence for the play state from our deep visual classifier. Each left-side chart shows conditional probability densities for the maximum optic flow and each right-side chart shows the deep network P(play) visual cues on Game 1. For Camera 3, four conditional distributions are shown, including the distributions for start and stop whistles, to use in the 4-state HMM. Note the superior discriminative power of the deep visual cue. FIGS. 14 to 14C show the conditional densities for the auditory cue of Camera 3 (log of the Weiner filter 3 response, normalized to have zero mean and unit variance) for Game 1, Game 2, and Game 3, respectively.

In some cases, the state transition probabilities and emission distributions used in the HMMs may vary slightly with each fold of the k-fold cross-validation.

The example experiments employed a Viterbi algorithm to efficiently determine the maximum a posteriori sequence of hidden states given the observations. One limitation of this approach is that it treats all errors equally, whereas one might expect that mislabeling a play state as a no-play state might be more serious than mislabeling a no-play state as a play state, as the former could lead to the viewer missing a key part of the game, whereas the latter would just waste a little time. To handle this issue, a play bias parameter α≥1 was used that modifies the transition matrix to upweight the probability of transitions to the play state, down-weighting other transitions so that each row still sums to 1. Varying this parameter allows the system to sweep out a precision-recall curve for each camera. To compress the videos, any frames estimated to be play frames were retained and any frames estimated to be no-play frames were excised.

The example experiments were evaluated using precision-recall for retaining play frames (Cameras 1 and 2) and retaining play and whistle frames (Camera 3):

$$Precision = \frac{\# play \& whistle frames retained}{\# frames retained} \qquad ( 16 )$$

$$Recall = \frac{\# play \& whistle frames retained}{\# play \& whistle frames in video} \qquad ( 17 )$$

The percent (%) compression at each rate of recall was also determined.

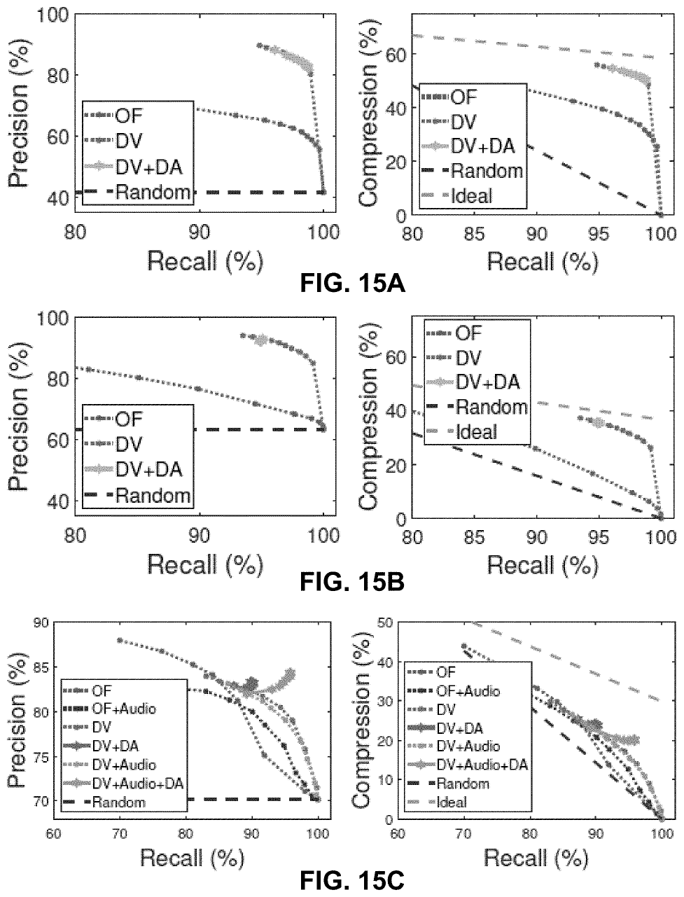

FIGS. 15A to 15C show results, averaged over all leave-one-game-out folds, for Camera 1, Camera 2, and Camera 3, respectively. FIGS. 15A to 15C show HMM cross-validated performance; where OF: Optical flow, DV: Deep visual feature, DA: Domain adaptation. For Camera 3, the example experiments evaluated using a 2-state HMM with only visual cues as well as a 4-state HMM with both visual and audio cues. For reference, shown is a lower bound of the performance of a baseline that excises random frames, and as an upper bound the compression-recall attained by an ideal model that first excises all non-play frames before beginning to excise play frames.

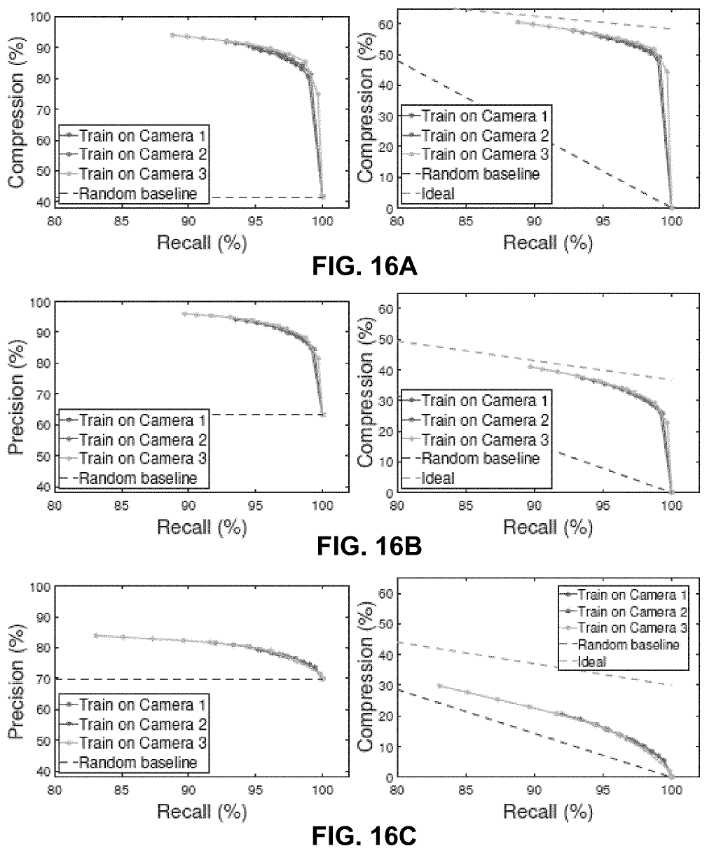

The deep visual cue clearly outperforms the optic flow cue for all cameras. Interestingly, while the optic flow cue clearly benefits from integration with the audio cue, the deep visual cue seems to be strong enough on its own, and no sensory integration benefit is necessarily observed. FIGS. 16A to 16C show performance of deep visual cues for Camera 1, Camera 2, and Camera 3, respectively; where the left charts are precision-recall curves, and the right charts are compression-recall curves. FIGS. 16A to 16C show that these deep visual cues generalize well across the three camera systems.

As described, the visual cues and the auditory cues can be used as observations inputted to the HMM. In the example experiments, since Cameras 1 and 2 did not record audio, only the visual cue were available. Hence, the 2-state model (play/no-play) of FIG. 12A was used. As Camera 3 recorded audio, the 4-state model of FIG. 12B was used. The initial state probabilities were determined from the training data as the percentage of frames belonging to either a Play or No-play state across all games for each camera. In another example experiment, such results are seen in Table 4 that shows mean initial state probabilities for each camera.

TABLE 4

Initial probabilities (π)

| Camera | Play | No-play |
|---|---|---|
| 1 | 0.629 | 0.371 |
| 2 | 0.656 | 0.344 |
| 3 | 0.699 | 0.301 |

Similarly, the probability of transitioning between states can be computed from the training data as the proportion of frames where the desired transition happens. For example, the transition probability of going from No-play state to Play state can be computed as the fraction of No-play frames where the next state was Play. Example results are illustrated in Table 5 that shows mean state transition probabilities for each camera.

TABLE 5

| Camera | Transition | Probability |
|---|---|---|
| 1 | No-play→Play | 0.00100 |
| 1 | Play→No-play | 0.00053 |
| 2 | No-play→Play | 0.00092 |
| 2 | Play→No-play | 0.00054 |
| 3 | No-play→Start | 0.00117 |
| | Whistle | |
| 3 | Start | 0.04973 |
| | Whistle→Play | |
| 3 | Play→Stop | 0.00050 |
| | Whistle | |
| 3 | Stop | 0.04709 |
| | Whistle→No-play | |

The auditory and visual cues were normalized to have zero-mean and unit-variance. The two features were assumed to be conditionally independent. Hence, in this example experiment, the observation likelihoods were modelled separately. In order to model the auditory and visual cues using a GMM, an optimal number of components was determined. The number of components were varied and an AUC score for classifying play and no-play frames was determined. The GMM model was trained using training data comprising captured and labelled games. Given a test game, the ratio of the likelihoods of play and no-play states was used to compute the AUC score for that game. The AUC score was averaged across all games for each camera through leave-one-out cross validation. The results are shown in Table 6, showing illustrating cross-validated AUC scores as a function of the number of GMM components (where OF is maximum optic flow cue and DV is deep visual cue).

TABLE 6

| # of GMM | 2-state HMM | | 4-state HMM | |
|---|---|---|---|---|
| components | OF | DV | OF + Audio | DV + Audio |
| 1 | 0.8394 | 0.9149 | 0.7366 | 0.7337 |
| 2 | 0.8398 | 0.9150 | 0.7378 | 0.7349 |
| 3 | 0.8399 | 0.9152 | 0.7433 | 0.7454 |
| 4 | 0.8374 | 0.9151 | 0.7369 | 0.7346 |
| 5 | 0.8387 | 0.9150 | 0.7378 | 0.7363 |
| 7 | 0.8387 | 0.9143 | 0.737 | 0.7362 |
| 10 | 0.8379 | 0.9145 | 0.7374 | 0.7368 |

The example experiments found that the discriminative power of the deep visual cue was superior to that of the maximum optic flow cue. The 3-component GMM achieved the best results for both 2-state and 4-state HMM using either visual cue. For the 4-state model, the likelihoods of the whistle states were added to the likelihood of the play state.

Since the KDE models a Gaussian for each data point, it can get computationally expensive for long sequences/videos. In the example experiments, the present inventors computed the histogram of the visual and auditory cues for a specified number of bins and then modelled the histogram of the observations using a Gaussian KDE. In a similar manner to the analysis for the optimal number of GMM components, the AUC score was used to determine the optimal number of histogram bins. The results are illustrated in Table 7, which shows that histogram of the visual and auditory cues were computed for the specified number of bins and modelled using a Gaussian KDE; where the AUC score for classifying play and no-play frames was computed. The discriminative power of the deep visual cue was superior to that of the maximum optic flow cue. The best results were obtained when the observation was a 32-bin histogram.

TABLE 7

| # histogram | 2-state HMM | | 4-state HMM | |
|---|---|---|---|---|
| bins | OF | DV | OF + Audio | DV + Audio |
| 8 | 0.8221 | 0.8984 | 0.6704 | 0.6661 |
| 16 | 0.8345 | 0.9099 | 0.6967 | 0.6952 |
| 32 | 0.8376 | 0.9143 | 0.6986 | 0.7008 |
| 64 | 0.8376 | 0.9142 | 0.6904 | 0.6881 |
| 128 | 0.8373 | 0.9141 | 0.675 | 0.6747 |
| 256 | 0.8372 | 0.9136 | 0.6598 | 0.6603 |
| 512 | 0.8367 | 0.9133 | 0.6442 | 0.6471 |
| 1024 | 0.8360 | 0.9126 | 0.629 | 0.6338 |

As seen in Table 6 and Table 7, the AUC score was better when modelling the likelihoods using a GMM rather than KDE. Hence, modelling the likelihoods using a 3-component Gaussian Mixture Model (GMM) provides substantial advantages.

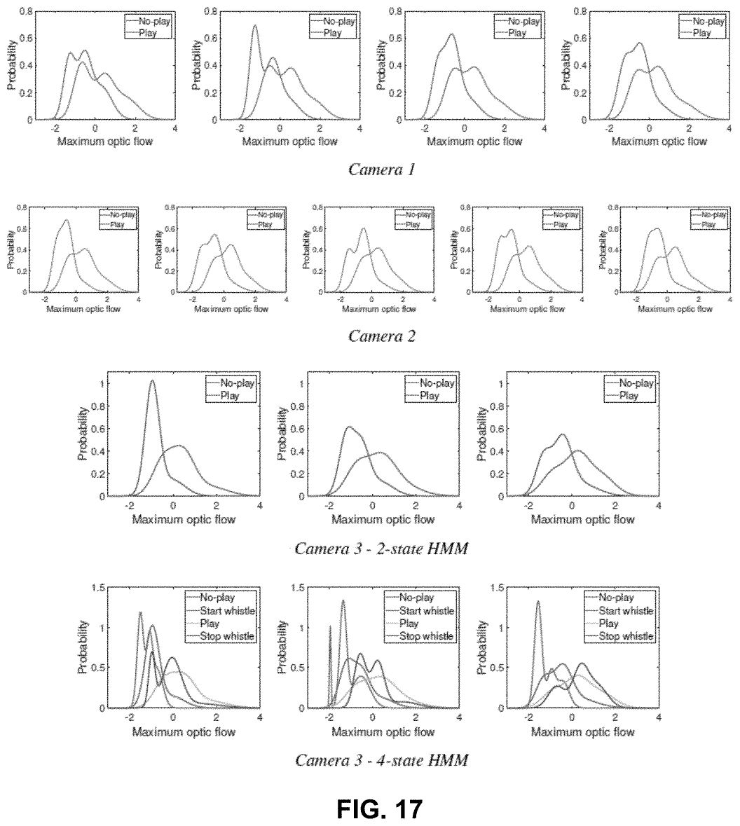

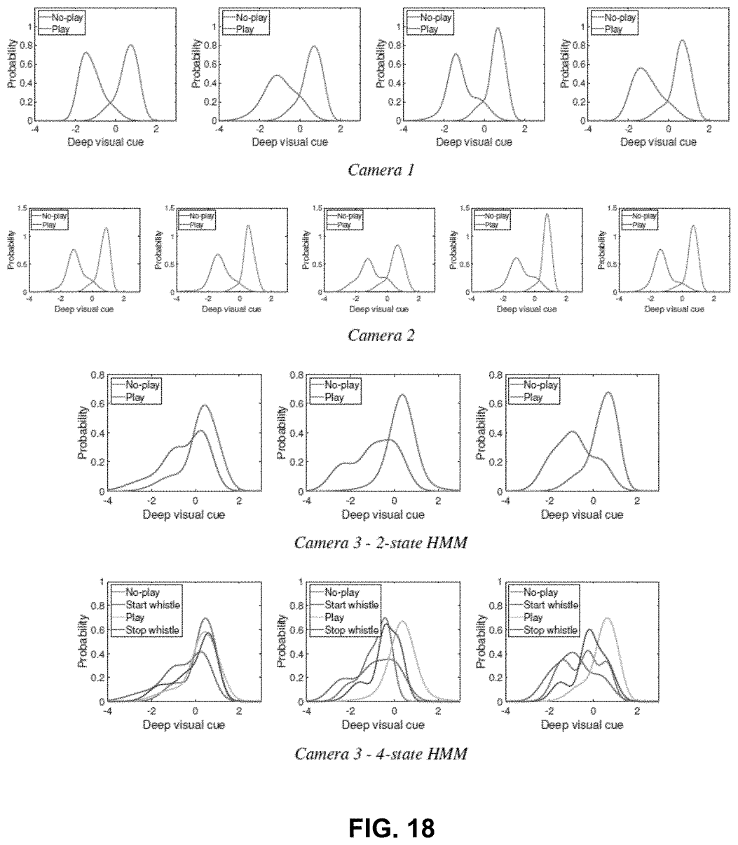

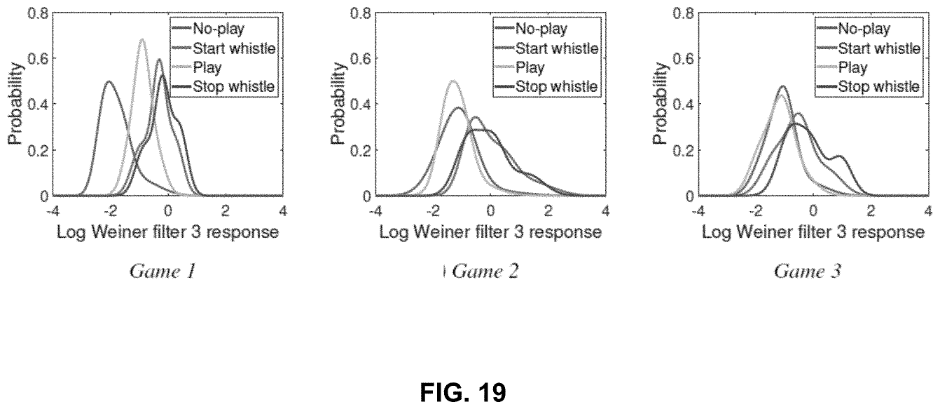

FIG. 17 illustrates conditional probability densities for the maximum optic flow visual cue on all games across all three cameras. FIG. 18 illustrates conditional probability densities for the deep visual cue on all games across all three cameras. The conditional densities for the auditory cue of Wiener filter 3 detector on games from Camera 3 are shown in FIG. 19; where only Camera 3 was recorded with audio. Hence, four conditional densities are shown for Camera 3, including the distributions for start and stop whistles. The two whistle states are considered to be a part of play when reducing the 4-state HMM to a 2-state HMM.

A fundamental part of machine learning is the problem of generalization, that is, how to make sure that a trained model performs well on unseen data. If the unseen data has a different distribution, i.e., a domain shift exists, the problem is significantly more difficult. The system 150 learns emission probabilities by modelling the observation likelihoods using, in some cases, a 3-component GMM on the training data. If the observation distribution is different between the captured games in the training and test data, then there is a risk that the emission probabilities on the test data are wrong; and this will affect the estimated state sequence. In some cases, the emission probabilities of the HMM at inference can be adapted to accommodate these domain shifts.

Unsupervised HMM parameter learning can be performed using the Baum-Welch algorithm, which is a special case of the EM algorithm. The Baum-Welch algorithm allows learning both the state transition probabilities A and the emission probabilities B. This is the third problem (learning) that is characterized by using an HMM. Forward and backward probabilities can be used to learn the state transition and emission probabilities.

Let O={o₁, o₂, . . . , o_{T}} be a sequence of observations and Q={q₁, q₂, . . . , q_{T}} be a sequence of hidden states. Let αₜ(j) be the probability of being in state j after seeing the first t observations. Let βₜ(j) be the probability of seeing the observations from time t+1 to T, given that the system is in state j at time t. Let γₜ(j) be the probability of being in state j at time t, given all observations. The state transition probabilities A can be determined by defining âᵢⱼ as:

$${\hat{a}}_{ij} = \frac{expected number of transitions from state i to state j}{expected number of transitions from state i} \qquad ( 18 )$$

The probability of being in state i at time t and state j at time t+1, given the observation sequence O and HMM λ=(A, B), is given as:

$${ξ}_{t} ( i , j ) = P ( {q}_{t} = i , {q}_{t + 1} = j \vert O , λ ) = \frac{P ( {q}_{t} = i , {q}_{t + 1} = j , O \vert λ )}{P ( O \vert λ )} = \frac{{α}_{t} ( i ) {a}_{ij} {b}_{j} ( {o}_{t + 1} ) {β}_{t + 1} ( j )}{{\sum }_{k = 1}^{N} {α}_{t} ( k ) {β}_{t} ( k )} \qquad ( 19 )$$

The expected number of transitions from state i to state j can be obtained by summing ξᵢ(i,j) over all frames t. Using Equation (19), Equation (18) can be rewritten as:

$${\hat{a}}_{ij} = \frac{{\sum }_{t = 1}^{T - 1} {ξ}_{t} ( i , j )}{{\sum }_{t = 1}^{T - 1} {\sum }_{k = 1}^{N} {ξ}_{t} ( i , k )} \qquad ( 20 )$$

The observation likelihoods can be modelled using a 3-component GMM. Thus, the probability of seeing observation oₜ in state j is given as:

bⱼ(oₜ)=Σₖ₌₁^{M}ϕₖⱼ [symbol] (oₜ; μₖⱼ, σₖⱼ²) (21)

where ϕₖⱼ, μₖⱼ and σₖⱼ² are the weight, mean and variance of the k^{th} component of the GMM of state j, and [symbol] is the Gaussian distribution with mean μₖⱼ and variance σₖⱼ².

Knowing the state for each observation sample, then estimating the emission probabilities B can be performed. The posterior probability γₜ(j) gives the probability that observation oₜ came from state j. The Baum-Welch algorithm updates the weights, means and variances of the GMM as:

$${\hat{ϕ}}_{kj} = \frac{{\sum }_{t = 1}^{T} {P}_{j} ( k \vert {o}_{t} , Φ ) {γ}_{t} ( j )}{{\sum }_{t = 1}^{T} {γ}_{t} ( j )} \qquad ( 22 )$$

$${\hat{μ}}_{kj} = \frac{{\sum }_{t = 1}^{T} {o}_{t} {P}_{j} ( k \vert {o}_{t} , Φ ) {γ}_{t} ( j )}{{\sum }_{t = 1}^{T} {γ}_{t} ( j )} \qquad ( 23 )$$

$${\hat{σ}}_{kj}^{2} = \frac{{\sum }_{t = 1}^{T} {( {o}_{t} - {\hat{μ}}_{kj} )}^{2} {P}_{j} ( k \vert {o}_{t} , Φ ) {γ}_{t} ( j )}{{\sum }_{t = 1}^{T} {γ}_{t} ( j )} \qquad ( 24 )$$

where Φ represents the current set of GMM parameters. Pⱼ(k|oₜ, Φ) is the probability that the observation oₜ was from the k^{th} component of the GMM of state j. It is given as:

$${P}_{j} ( k \vert {o}_{t} , Φ ) = \frac{{ϕ}_{kj} 𝒩 ( {o}_{t} ; {μ}_{kj} , {σ}_{kj}^{2} )}{{\sum }_{m = 1}^{M} {ϕ}_{mj} 𝒩 ( {o}_{t} ; {μ}_{mj} , {σ}_{mj}^{2} )} \qquad ( 25 )$$

Thus, the state transition probabilities A can be estimated using Equation (20), and the emission probabilities B using Equations (22), (23) and (24). The iterative Baum-Welch algorithm can be performed as follows:
Initialize the state transition probabilities A and emission probabilities B.
Use Equation (16) to estimate γₜ(j) given the state transition matrix A and emission probabilities B.
Use γₜ(j) to update the state transition probabilities A and emission probabilities B
Repeat iteratively until the difference in the log-likelihood between five successive iterations is less than a given threshold (e.g., 0.1).

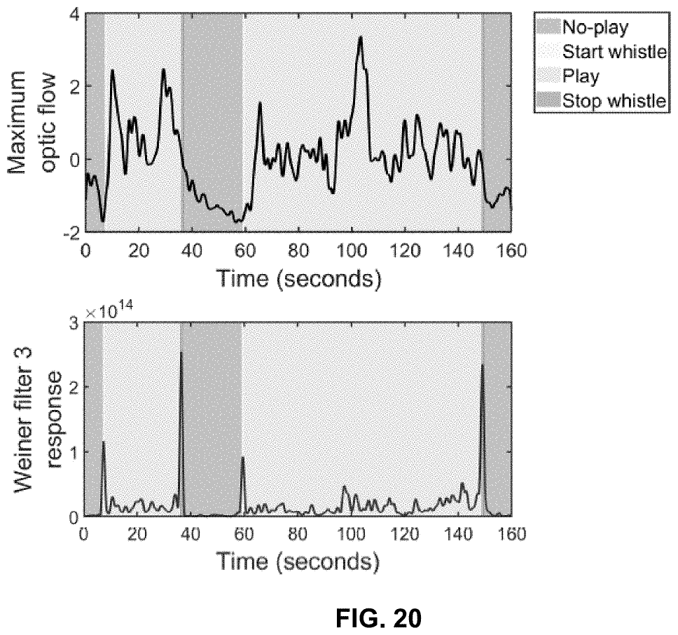

FIG. 20 shows an example of how the visual cue of maximum optic flow and auditory cue of Wiener filter 3 detector varies over time within each game state, for a 160-second sample video from Game 1 recorded using Camera 3. It is observed that Wiener filter 3 has a sharp response during whistle periods. Thus, players moving faster during play than breaks (no-play) is evidenced by the large values of the maximum optic flow cue during play frames and lower values during no-play frames.

Using the forward-backward approach, the probability of being in state j at time t, γₜ(j), for each state across all frames of the video. To temporally compress the video, frames were cut if P(no-play) exceeds a threshold ηₒ. In this case, precision, recall and compression can be defined as:

$$Precision = \frac{\# play \& whistleframesretained}{\# framesretained} \qquad ( 26 )$$

$$Recall = \frac{\# play \& whistleframesretained}{\# play \& whistleframesinvideo} \qquad ( 27 )$$

$$Compression = 1 - \frac{\# framesretained}{\# framesinvideo} \qquad ( 28 )$$

Varying ηₒ sweeps out a precision-recall curve. Since no audio was available for Cameras 1 and 2, the precision and recall were evaluated for retaining play frames only. For Camera 3, as audio was available, the precision and recall were evaluated for retaining both play and whistle frames.

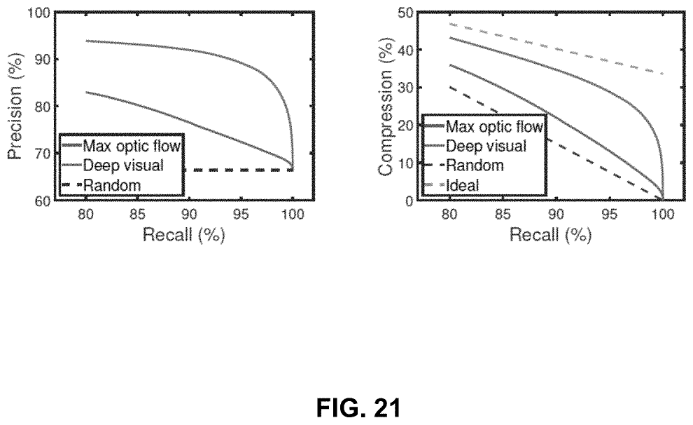

The example experiments evaluated the generalization of the system across different games for each camera by measuring the within-camera performance through leave-one-out cross validation. For each camera, the precision, recall and compression were measured through leave-one out cross validation across all games. These were then averaged across all three cameras. The within-camera performance of the 2-state HMM (using visual cue only) is shown in FIG. 21. It was compared against two baselines: 1) Random: the lower bound baseline that randomly removes frames, and 2) Ideal: the upper bound of an ideal model that accurately removes all no-play frames, before beginning to remove play frames. The within-camera performance was determined using both the maximum optic flow cue and deep visual cue. Both cues were found to be significantly better than lower bound baseline (Random). The performance of the deep visual cue was significantly better than the maximum optic flow cue.

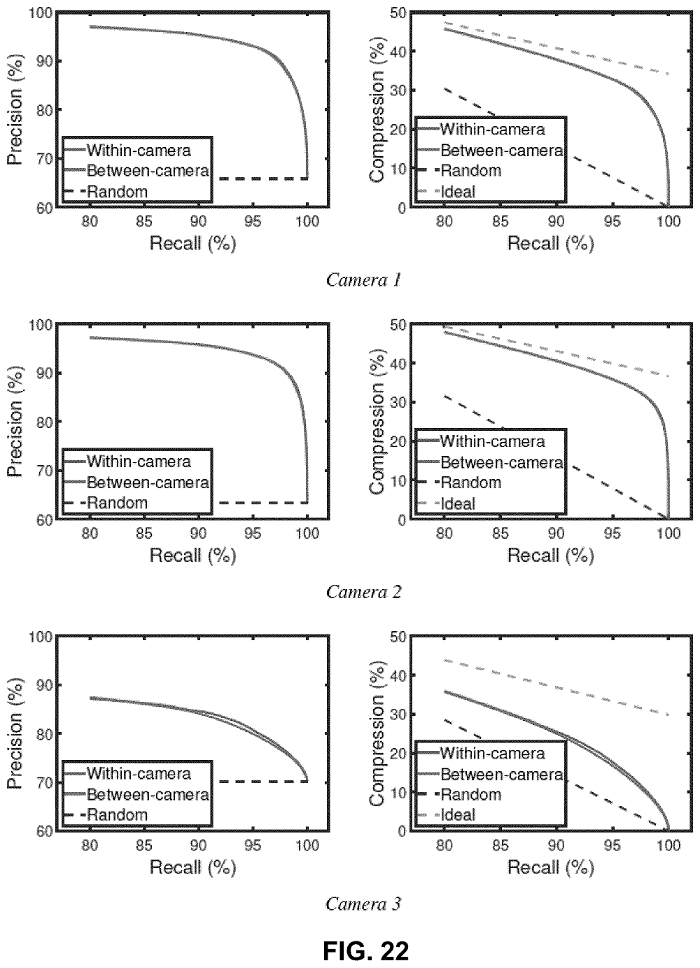

The generalization of the system 150 across different cameras was determined by measuring the between-camera performance. The 2-state HMM was trained on all games from two cameras and then evaluated on the games from the third camera. For example, a model was trained on all games from Cameras 1 and 2 and then evaluated on all games from Camera 3. The between-camera performance was compared to the within-camera performance on the third camera, as shown in FIG. 22.

It was determined that between-camera performance was very similar to the within-camera performance across all cameras. Thus, the model is able to generalize to different games, rinks and lighting conditions. The performance was worse on Camera 3 as compared to Cameras 1 and 2. Since Camera 3 was positioned closer to the ice surface as compared to Cameras 1 and 2, the fans are more visible and cause more occlusions in the video recording. Hence, the performance of the player detector could have been poorer on Camera 3, leading to less discriminative deep visual cues. In addition to occlusions, if the fans were moving during periods of no-play, this would also make the deep visual cue less discriminative.

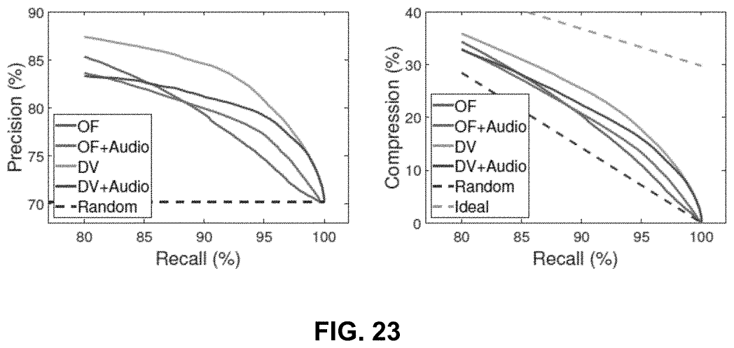

The performance of the 4-state HMM that combines visual and auditory cues was also evaluated. Three games were recorded with audio using Camera 3. The performance of the 4-state HMM on these three games was evaluated through leave-one-out cross validation. The precision, recall and compression were averaged across all three games. FIG. 23 illustrates performance of the 2-state HMM and 4-state HMM on Camera 3. The 4-state HMM combined visual and auditory cues, while the 2-state HMM used only the visual cues. Combining auditory cues with the maximum optic flow cue significantly improved performance. However, no benefit was observed upon integration of the deep visual cue with the auditory cue.

The example experiments failed to observe any benefit of integrating the visual and auditory cues for Camera 3 once the strong deep visual cue was used. While the deep visual cues generalized well across cameras, the emission distributions of the auditory cues for Camera 3 seem to vary substantially across games. This could indicate a domain shift between the training and test data for the auditory cues. This domain shift was examined by analysing the fit of the unconditional emission distribution learned from the training data on the test data. The unconditional emission distribution was determined as:

f(x)=Σᵢ₌₁^{N}fᵢ(x)P(i) (29)

where fᵢ(x) and P(i) are the emission distribution and prior for state i, respectively. N is the number of states; N=2 or N=4 in this example.

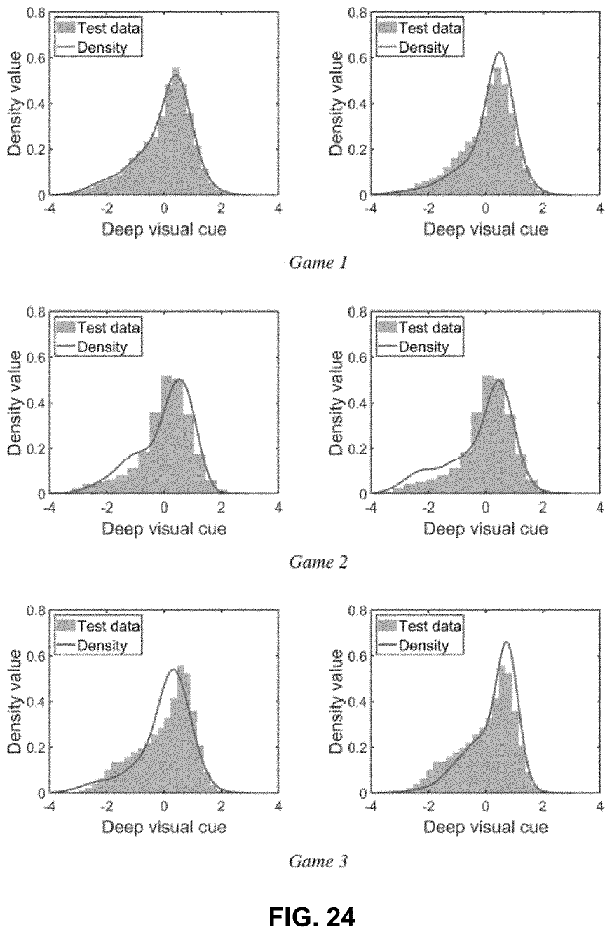

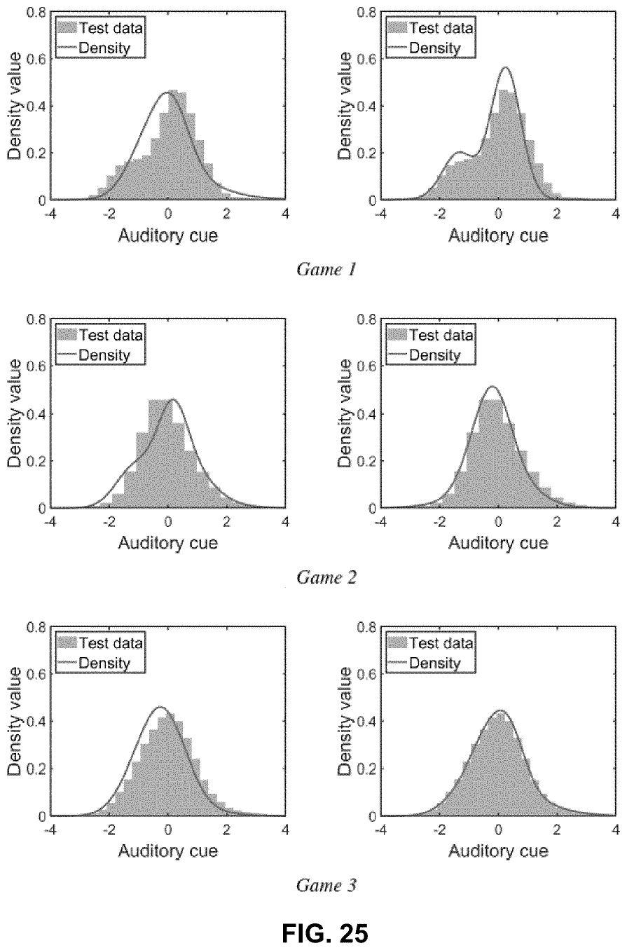

FIGS. 24 and 25 visualize the unconditional densities learned from the training data on the histogram of the test data. A slight domain shift in the emission distribution for the deep visual cue was observed on Game 3. For the auditory cue, a substantial domain shift for Games 1 and 2 was observed. FIG. 24 illustrates unconditional densities of the deep visual cue learned from the training data shown on the test data histogram for each game recorded using Camera 3; where left side is before adaptation and right side is after adaptation. FIG. 25 illustrates unconditional densities of the auditory cue learned from the training data shown on the test data histogram for each game recorded using Camera 3; where left side is before adaptation and right side is after adaptation.

Domain shift can be overcome by adapting the HMM to the test data at inference. The Baum-Welch algorithm can be used for unsupervised HMM parameter learning. As described herein, both the emission probabilities and the state transition probabilities can be updated. The percent change in the values of the state transition matrix A, between the training and test games for Camera 3, can be determined. The change across all three cross-validations folds can be averaged.

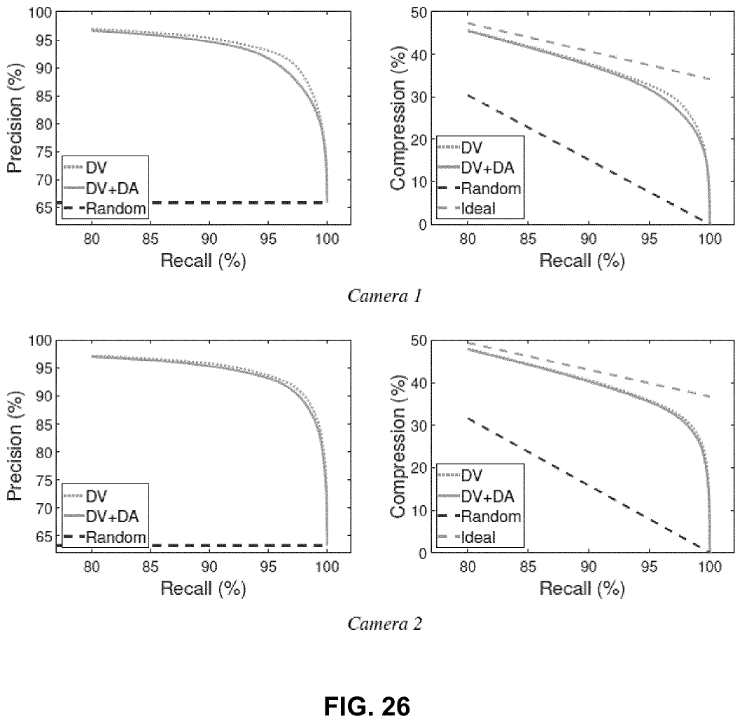

It was found that the average is to be 4.48%. This is a small change that will not generally influence the model performance. Empirically, it was found that updating the transition probabilities did not make any difference in the model performance. Hence, only the emission probabilities needed to be updated. There was a dramatic improvement in the performance of 4-state HMM (visual and auditory cue) after domain adaptation. In a similar manner, the performance of the 2-state HMM (visual cue only) before and after domain adaptation on Cameras 1 and 2 was determined. The unconditional densities before and after domain adaptation are shown in FIGS. 24 and 25 for Camera 1 and Camera 2, respectively. It was found that the emission distributions for the deep visual cue learned on the training data, modelled the test data distributions well. Hence, there was no benefit found with domain adaptation, as seen in the precision-recall performance plots in FIG. 26.

As evidenced in the example experiments, the present embodiments provide an effective approach for automatic play-break segmentation for recorded sports games, such as hockey. It can be used to abbreviate game videos while maintaining high recall for periods of active play. With a modest dataset, it is possible to train a small visual deep network to produce visual cues for play/no-play classification that are much more reliable than a simple optic flow cue. Incorporation of an HMM framework accommodates statistical dependencies over time, allowing effective play/break segmentation and temporal video compression. Integration of auditory (whistle) cues could boost segmentation performance by incorporating unsupervised adaptation of emission distribution models to accommodate domain shift. Embodiments of the present disclosure were found to achieve temporal compression rates of 20-50% at a recall of 96%.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

1. A computer-implemented method for automated video segmentation of an input video signal, the input video signal capturing a playing surface of a team sporting event, the method comprising:
receiving the input video signal;
determining player position masks from the input video signal;
determining optic flow maps from the input video signal;
determining visual cues using the optic flow maps and the player position masks;
classifying temporal portions of the input video signal for game state using a trained hidden Markov model, the game state comprising either game in play or game not in play, the hidden Markov model receiving the visual cues as input features, the hidden Markov model trained using training data comprising a plurality of visual cues for previously recorded video signals each with labelled play states; and
outputting the classified temporal portions.

2. The method of claim 1, further comprising excising temporal periods classified as game not in play from the input video signal, and wherein outputting the classified temporal portions comprises outputting the excised video signal.

3. The method of claim 1, wherein the optic flow maps comprise horizontal and vertical optic flow maps.

4. The method of claim 1, wherein the hidden Markov model outputs a state transition probability matrix and a maximum likelihood estimate to determine a sequence of states for each of the temporal portions.

5. The method of claim 4, wherein the maximum likelihood estimate is determined by determining a state sequence that maximizes posterior marginals.

6. The method of claim 4, wherein the hidden Markov model comprises Gaussian Mixture Models.

7. The method of claim 4, wherein the hidden Markov model comprises Kernel Density Estimation.

8. The method of claim 4, wherein the hidden Markov model uses a Baum-Welch algorithm for unsupervised learning of parameters.

9. The method of claim 1, wherein the visual cues comprises maximum flow vector magnitudes within detected player bounding boxes, the detected player bounding boxes determined from the player position masks.

10. The method of claim 3, wherein the visual cues are outputted by an artificial neural network, the artificial neural network receiving a multi-channel spatial map as input, the multi-channel spatial map comprising the horizontal and vertical optic flow maps, the player position masks, and the input video signal, the outputted visual clues comprise conditional probabilities of the logit layers of the artificial neural network, the artificial neural network trained using previously recorded video signals each with labelled play states.

11. A system for automated video segmentation of an input video signal, the input video signal capturing a playing surface of a team sporting event, the system comprising one or more processors in communication with data storage, using instructions stored on the data storage, the one or more processors are configured to execute:
an input module to receive the input video signal;
a preprocessing module to determine player position masks from the input video signal, to determine optic flow maps from the input video signal, and to determine visual cues using the optic flow maps and the player position masks;
a machine learning module to classify temporal portions of the input video signal for game state using a trained hidden Markov model, the game state comprising either game in play or game not in play, the hidden Markov model receiving the visual cues as input features, the hidden Markov model trained using training data comprising a plurality of visual cues for previously recorded video signals each with labelled play states; and
an output module to output the classified temporal portions.

12. The system of claim 11, wherein the output module further excises temporal periods classified as game not in play from the input video signal, and wherein outputting the classified temporal portions comprises outputting the excised video signal.

13. The system of claim 11, wherein the optic flow maps comprise horizontal and vertical optic flow maps.

14. The system of claim 11, wherein the hidden Markov model outputs a state transition probability matrix and a maximum likelihood estimate to determine a sequence of states for each of the temporal portions.

15. The system of claim 14, wherein the maximum likelihood estimate is determined by determining a state sequence that maximizes posterior marginals.

16. The system of claim 14, wherein the hidden Markov model comprises Gaussian Mixture Models.

17. The system of claim 14, wherein the hidden Markov model comprises Kernel Density Estimation.

18. The system of claim 15, wherein the hidden Markov model uses a Baum-Welch algorithm for unsupervised learning of parameters.

19. The system of claim 15, wherein the visual cues comprises maximum flow vector magnitudes within detected player bounding boxes, the detected player bounding boxes determined from the player position masks.

20. The system of claim 13, wherein the visual cues are outputted by an artificial neural network, the artificial neural network receiving a multi-channel spatial map as input, the multi-channel spatial map comprising the horizontal and vertical optic flow maps, the player position masks, and the input video signal, the outputted visual clues comprise conditional probabilities of the logit layers of the artificial neural network, the artificial neural network trained using previously recorded video signals each with labelled play states.
